(19) United States
(12) Patent Application Publication
(10) Pub. No.: US 2005/0146753 A1
(43) Pub. Date: Jul. 7, 2005

(54) Multi-functional printer device

(76) Inventors: Jonathan Firooz, Vancouver, WA (US); Charles R. Weirauch, Loveland, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/750,791

(22) Filed: Jan. 2, 2004

(51) Int. Cl. H04N 1/00

(52) U.S. Cl. 358/440; 358/448

(57) ABSTRACT

A method for receiving facsimiles in a multi-function printer device comprises detecting, by the multi-function printer device, an incoming phone call, monitoring, by the multi-function printer device, the incoming phone call for a facsimile tone while the incoming call is answered, continuing to monitor, by the multi-function printer device, the incoming phone call for a facsimile tone after the incoming call is answered, allowing, by the multi-function printer device, the incoming call to proceed when no facsimile tone is detected, and initializing the multi-function printer device to receive an incoming facsimile transmission in response to the facsimile tone being detected.

### CROSS-REFERENCE TO RELATED APPLICATIONS

This application is related to commonly assigned and concurrently filed U.S. patent application Nos. [Attorney Docket No. 200205924-1] entitled “MULTI-FUNCTIONAL PRINTER DEVICE”, and [Attorney Docket No. 200205923-1] entitled “MULTI-FUNCTIONAL PRINTER DEVICE”, the disclosures of which are incorporated herein by reference.

### FIELD OF THE INVENTION

The present invention is broadly related to multi-function printers, and more specifically to systems and methods for automatically detecting incoming voice or fax transmissions by a fax capable multi-function printer device to route calls accordingly.

### DESCRIPTION OF RELATED ART

Initially, facsimile, or fax, technology was primarily developed for commercial use as a means of transmitting copies of documents without employing conventional mail or courier services. The standard fax machine can be connected to a dedicated telephone line that is not shared by any other device, such as an answering machine in a consumer setting, or even a credit card reader in a commercial setting. For some businesses it is typically not a great burden to pay a few extra dollars per month for a separate line for a critical device such as a fax machine.

However, it is becoming more common and more useful for consumers and small businesses to have fax capability. Yet, consumers and small businesses that cannot dedicate a line to a fax machine are may have additional burdens. For example, conflicts can arise between an answering machine and a traditional fax machine in that most fax machines will answer after a certain number of rings, in a fashion similar to a typical answering machine. Thus, in unattended situations, one device will pick-up, preempting operation of the other device. In some instances, consumers and small businesses that cannot dedicate a line to a fax machine may either receive voice messages or unattended faxes, but not both.

Modern multi-function printers, also known as all-in-one devices, may include fax, as well as copy, scan and print capability. A user wanting to use the fax functionality of a multi-function printer device would typically either turn off their answering machine when they expect a fax, or conversely turn off the fax when they expect a voice message, unless they subscribe to separate phone lines for each device.

### BRIEF SUMMARY OF THE INVENTION

An embodiment of a method for receiving facsimiles in a multi-function printer device comprises detecting, by the multi-function printer device, an incoming phone call, monitoring, by the multi-function printer device, the incoming phone call for a facsimile tone while the incoming call is answered, continuing to monitor, by the multi-function printer device, the incoming phone call for a facsimile tone after the incoming call is answered, allowing, by the multi-function printer device, the incoming call to proceed when no facsimile tone is detected, and initializing the multi-function printer device to receive an incoming facsimile transmission in response to the facsimile tone being detected.

An embodiment of a multi-function printer device comprises means for printing media, means for optically scanning media, means for sending and receiving facsimiles, means for monitoring an incoming phone call for a facsimile tone from the incoming call being answered during the incoming call, and means for initializing the facsimile means to receive an incoming facsimile transmission in response to the monitoring means detecting a facsimile tone.

An embodiment of a system for automatically detecting incoming fax transmissions by a fax-capable multi-function printer device and routing a call according to a type of the call comprises a multi-function printer device comprising a printer, an optical scanner, a call monitor and a facsimile functionality, wherein the multi-function printer device monitors answered incoming phone calls to internally intercept incoming facsimile transmissions and initialize the facsimile functionality to receive the incoming facsimile transmissions, and the system comprises a general purpose processor-based device selectively interfaced with the multi-function printer device and selectively powered.

### BRIEF DESCRIPTION OF THE DRAWINGS

FIG. 1 illustrates a system employing an embodiment of the present invention; and

FIG. 2 is a flowchart of an embodiment of the present invention.

### DETAILED DESCRIPTION

The present invention does not require answering machine capability be built into a multi-function printer device. The present systems and methods provide a multi-function printer device, such as an all-in-one device, with a capability to switch and/or monitor incoming calls intelligently to determine whether the incoming call is a fax transmission or a voice transmission and process the call appropriately. In various embodiments the present systems and methods such processing of calls appropriately is provided by a fax-capable multi-function printer device that automatically detects incoming facsimile transmissions and internally routes these fax calls to an internal fax functionality of the multi-function printer device. Various embodiments of the present systems and methods allow non-fax calls to continue without interruption. The present invention monitors incoming calls answered by an answering machine or an individual. In at least one alternative embodiment the answering machine or phone need not necessarily be connected to the multi-function printer device. However, a telephone or answering machine connected to the multi-function printer device of the present invention may be connected directly to the device or indirectly connected to the device, such as a phone connected to an answering machine that is directly connected to the device. When a person or an answering machine answers a call, the multi-function printer device silently monitors for a fax tone while the answering machine is playing its outgoing message or while an answering person is listening or talking such as while speaking a greeting. If the device recognizes a fax tone, the device disconnects the line-out port that may be connected to the phone or the answering machine, and starts synchronizing and connecting to receive the fax transmission. If the device does not detect a fax tone, the device may allow the call to proceed as a voice call, without interruption or interception.

Alternative embodiments of the present invention may not only monitor for a fax tone, but may also monitor for incoming sound, such as a voice. If no incoming sound is detected, the present systems and methods may initiate a fax receive process lest a sending fax machine is not employing an initiating fax tone.

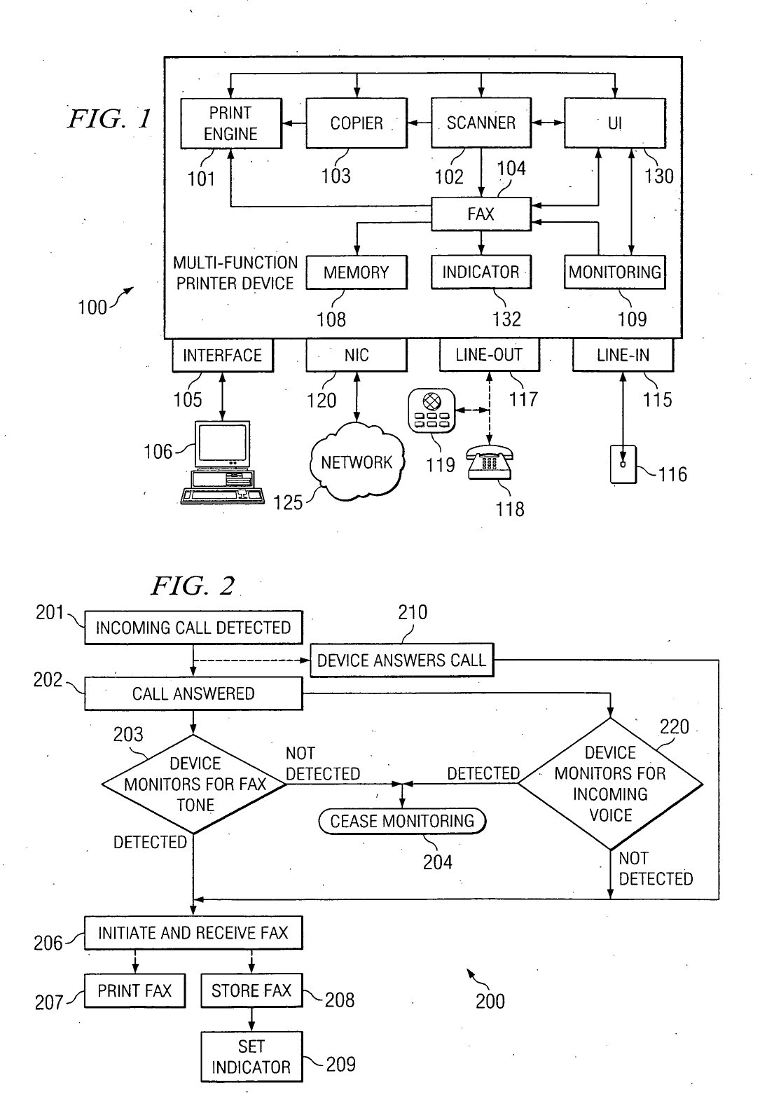

FIG. 1 is a diagrammatic illustration of an embodiment of “all-in-one” multi-function printer device 100 provided in accordance with embodiments of the present invention. Multi-function printer device 100 has a print engine or media printing functionality 101 and media scanning functionality 102. Printing functionality 101 may be of several media printing types known in the art, such as laser or inkjet and may be black-and-white (grayscale) or color. Scanning functionality 102 may include technologies such as a flatbed optical scanner, a picture frame scanner, or the like. Preferably, printing and scanning functionalities 101 and 102 may be used in conjunction with connected general purpose processor-based device 106, such as a personal computer (PC) or the like. Also, scanning functionality 102 and printing functionality 101 together may provide copier functionality 103 either in a stand-alone fashion, without a need for any processing by general purpose processor-based device 106, and/or in conjunction with connected general purpose processor-based device 106.

Fax functionality 104 may use printing functionality 101 for printing received faxes and fax functionality 104 may receive scanned images from scanning functionality 102 to be used as outgoing faxes. Multi-function printer device 100 preferably has interface 105 for optionally interfacing with general purpose processor based device 106. Interface 105 may take the form of a parallel port, Universal Serial Bus (USB) port, FireWire (IEEE 1394) port, or the like. However, multi-function printer device 100 may operate as a stand-alone device, at least as an integrated stand-alone copier and/or fax device, without the need to be connected to general purpose processor based device 106, or without any need for general purpose processor based device to be in a powered-on status, if connected. Phone line-in 115 is preferably connected to a wall phone jack 116 or the like and phone line-out 117 may optionally be connected to at least one communication device such as telephone 118, answering machine 119, or the like. Phone line-in 115 and phone line-out 117 may be decoupled in present multi-function printer device 100, wherein the line-in and line-out ports of the present multi-function printer device may be independently addressed, and a signal sent to one port may not be provided at the other port.

Multi-function printer device 100 also preferably includes call monitoring functionality 109 that monitors for a fax tone after a call is answered. During an incoming call, at least initially, while connected answering machine 119 plays a greeting or when a person initially answers connected phone 118, multi-function printer device monitoring functionality 109 monitors the line for a fax tone coming from the caller. In most cases, if the call is from a fax machine the multi-function printer device will detect a standard tone sent by fax machines upon transmission. If this tone is detected the multi-function printer device will preferably connect to the call in a fax-reception mode by disconnecting telephone 118 or answering machine 119. However, if the call is from a person then no tone will be present, in which case the multi-function printer device 100 allows the call to proceed and may cease monitoring the line. Alternatively, monitor 109 may continue to monitor for a fax tone. Additionally, multi-function printer device 100 may also monitor for incoming sound such as a voice. If after some delay, such as may be pre-set or user settable, no incoming sound is detected during a call the present systems and methods may connect to the call in a fax-reception mode, in the event a sending fax machine is not employing an initiating fax tone.

Memory 108 resident in multi-function printer device 100 may be used to store received faxes. Memory 108 may take the form of volatile memory such as Random Access Memory (RAM), nonvolatile memory such as Read Only Memory (ROM) and/or Erasable Programmable read only Memory (EPROM) or a combination of volatile and nonvolatile memory. A combination of volatile and nonvolatile memory may, for example, use volatile memory to store transient data such as incoming faxes while nonvolatile memory may be used to store more permanent data such as default and/or user selected device settings. Memory 108 may be in addition to typical RAM or other memory associated with printer, scanner and/or copier functionality 101, 102 and /or 103. Memory 108 may be internal to multi-function printer device 100. However, RAM or other memory associated with general purpose processor-based device 106 may also or alternatively be employed to store incoming faxes or the like and/or device settings. Multi-function printer device 100 may additionally, or alternatively, include one or more slots to receive memory devices such as smart media, compact flash, IC media, or other forms of removable media, for storing faxes in addition to more conventional uses such as providing pictures directly to printer functionality 101. Alternatively, if multi-function printer device 100 is connected to general purpose processor-based device 106 and general purpose processor-based device 106 is powered on, general purpose processor-based device 106's hard drive or other storage media may be used to store faxes. Thereby, general purpose processor-based device 106 may be used to display the faxes, such as at a later time.

As noted above, embodiments of multi-function printer device 100 may be used as a stand-alone device. User interface (UI) 130 may facilitate such stand-alone operation, and preferably may also be employed when the present multi-function printer device is employed in conjunction with general purpose processor-based device 106. Interface 130 may, among other functions, facilitate sending of faxes and manual receiving of faxes, as well as providing an interface for user selection of device settings, downloading of faxes to memory devices, and/or other operations related to multi-function printer device 100. Alternatively or additionally, a user interface may be provided on general-purpose processor-based device 106. Preferably, once set-up using such a computer-provided UI, multi-function printer device 100 is enabled to function as a stand-alone device without the computer turned on and/or connected, only using the computer UI for configuration changes. Also, as a default, multi-function printer device 100 is preferably enabled to function as a fax device without any configuration set-up using UI 130 or a computer provided UI, through the use of default settings. Indicator 132, that may be a part of UI 130, may provide a visual and/or audio indication of one or more stored faxes.

Network interface 120, such as an Ethernet port, may also be provided by multi-function printer device 100 to provide interconnectivity to network 125, such as a wired local area network, a wide area network, the Internet, a public telephone network, and/or the like. Multi-function printer device 100 may also, or alternatively, employ one or more wireless technologies such as IEEE 802.11 wireless networking, BULETOOTH™, infrared (IR), or the like, to provide connectivity with general purpose processor-based device 106, network 125 and/or other devices or services such as a Personal Digital Assistant (PDA), a wireless local area network, and/or the like.

FIG. 2 flowcharts operation of an embodiment of present method 200 for providing a fax-capable “all-in-one” multi-function printer device with a capability to automatically detect incoming voice or data transmissions and route calls accordingly, such as by intercepting fax transmissions and allowing non-fax calls to proceed normally, without interruption. An incoming call is received and the present multi-function printer device detects the call at 201. Either a person, or an answering machine answers the call at 202. In either situation, the present multi-function printer device monitors the line at 203 for a fax tone indicating that a fax message is being sent. Monitoring at 203 may take place while an answering person is speaking a greeting or while an answering machine is playing an outgoing message. If the present device does not detect any sort of fax tone at 203, the device may cease monitoring the line at 204 and the call will proceed independent of the multi-function printer device. If a fax tone is detected at 203 then the present device preferably initiates a synchronization to receive the fax at 206 and may print the fax at 207 or store the fax in memory at 208. This memory may be internal to the multi-function printer device or may be associated with a connected general purpose processor-based device.

Alternatively, the multi-function printer device may both print (207) and store (208) the received fax. The multi-function printer device may store the received fax at 208 concurrently with receipt of the received fax at 206, prior to disconnecting, concurrently with disconnecting or following disconnecting. Preferably, if a received fax is stored at 208 an audio and/or visual indicator is set at 209. As a further alternative, if the all-in-one multi-function printer device is out of paper or otherwise incapable of printing at the time a fax is received, the multi-function printer device may store an incoming fax in memory and set an indicator. As yet another alternative, an option to save, print, or both print and save a received fax to memory, may be a user settable or selectable feature. As noted above, the memory used to store a received fax may be resident in the multi-function printer device, or memory/storage associated with a connected general-purpose processor-based device, such as a PC. Resident memory may be shared by various functionalities of the present multi-function printer device. The multi-function printer device may also provide forwarding functions for received faxes. Additionally or alternatively, the present multi-function printer device may afford an ability to download faxes to a connected PC, facilitating conversion and or forwarding of received faxes or messages via email or the like.

Additionally, if the call is not answered at 202, such as after a preset number of rings, fax functionality of the present device may answer the call at 210 and initiate a fax receive at 206. Preferably, the number of rings may either be set by the user, such as through one of the aforementioned UIs, or preset in the multi-function printer device as a default.

As noted above, embodiments of the present invention may monitor the line at 220 for incoming sound, such as a voice. If no sound is detected at 220 the present systems and methods may initiate a fax receive at 206 in an attempt to synchronize such as with a sending fax machine that is not employing an initiating fax tone.

1. A method for receiving facsimiles in a multi-function printer device, said method comprising:
detecting, by said multi-function printer device, an incoming phone call;
monitoring, by said multi-function printer device, said incoming phone call for a facsimile tone while said incoming call is answered;
continuing to monitor, by said multi-function printer device, said incoming phone call for a facsimile tone after said incoming call is answered;
allowing, by said multi-function printer device, said incoming call to proceed when no facsimile tone is detected; and
initializing said multi-function printer device to receive an incoming facsimile transmission in response to said facsimile tone being detected.

2. The method of claim 1 further comprising:
disconnecting said incoming call from a connected communication device by said multi-function printer device in response to detecting said facsimile tone.

3. The method of claim 1 further comprising:
continuing to monitor said incoming call, by said multi-function printer device, for a facsimile tone after allowing said incoming call to proceed.

4. The method of claim 1 further comprising:
monitoring said incoming call by said multi-function printer device for sound; and
initializing said multi-function printer device to receive an incoming facsimile transmission in response to no sound being detected during said monitoring said incoming call for sound.

5. The method of claim 1 further comprising storing said facsimile in memory of a general purpose processor based device connected to said multi-function printer device.

6. A multi-function printer device comprising:
means for printing media;
means for optically scanning media;
means for sending and receiving facsimiles;
means for monitoring an incoming phone call for a facsimile tone from said incoming call being answered during said incoming call; and
means for initializing the facsimile means to receive an incoming facsimile transmission in response to said monitoring means detecting a facsimile tone.

7. The multi-function printer device of claim 6 wherein said monitoring means comprises means for monitoring said incoming call for an initial period after said incoming call is answered.

8. The multi-function printer device of claim 6 wherein said monitoring means comprises means for continuing to monitor said incoming call for a facsimile tone throughout said incoming call.

9. The multi-function printer device of claim 6 further comprising means for initializing the facsimile means to receive an incoming facsimile transmission in response to no sound being detected by said monitoring means during recording of an incoming message.

10. The multi-function printer device of claim 6 further comprising means for interfacing with a general purpose processor-based device and wherein said device is a stand-alone device adapted to employ the facsimile means independent of a connection to said general purpose processor-based device.

11. The multi-function printer device of claim 6 further comprising means for wirelessly interfacing with a network.

12. The multi-function printer device of claim 6 further comprising means for wirelessly interfacing with a general purpose processor-based device.

13. The multi-function printer device of claim 6 further comprising means for receiving at least one memory device and means for downloading received faxes to said memory device.

14. The multi-function printer device of claim 6 wherein said scanning means comprises a flatbed optical scanner.

15. The multi-function printer device of claim 6 wherein said scanning means comprises a sheet-feed optical scanner.

16. The multi-function printer device of claim 6 wherein said scanning means comprises a picture frame scanner.

17. The multi-function printer device of claim 6 further comprising:
means for copying media as a combination of said printing means and said scanning means.

18. A system for automatically detecting incoming fax transmissions by a fax-capable multi-function printer device and routing a call according to a type of said call, said system comprising:
a multi-function printer device comprising:
a printer;
an optical scanner;
a call monitor; and
a facsimile functionality;
wherein said multi-function printer device monitors answered incoming phone calls to internally intercept incoming facsimile transmissions and initialize said facsimile functionality to receive said incoming facsimile transmissions; and
a general purpose processor-based device selectively interfaced with said multi-function printer device and selectively powered.

19. The system of claim 18 wherein said facsimile functionality stores said incoming facsimiles to memory of said general purpose processor-based device.

20. The system of claim 18 wherein said general purpose processor-based device hosts a user interface adapted to receive user settings for said multi-function printer device.

21. The system of claim 20 wherein said user settings comprise a number of rings before said facsimile functionality answers an incoming call and initiates facsimile reception.

22. The system of claim 18 wherein said a multi-function printer device is a stand-alone device adapted to employ said facsimile functionality independent of said interface with said general purpose processor-based device.

23. The system of claim 18 wherein said multi-function printer device is a stand-alone device adapted to employ said facsimile functionality independent of a power status of said general purpose processor-based device.

24. The system of claim 18 wherein said multi-function printer device further comprises a wireless interface, interfacing said general purpose processor-based device with said multi-function printer device.
